(19) United States
(12) Patent Application Publication
(10) Pub. No.: US 2006/0172557 A1
(43) Pub. Date: Aug. 3, 2006

(54) Electrical actuator having smart muscle wire

(76) Inventor: Xinhua (Sam) He, Troy, MI (US)

Correspondence Address: DELPHI TECHNOLOGIES, INC., M/C 480-410-202, PO BOX 5052, TROY, MI, 48007, US

(21) Appl. No.: 10/548,972

(22) PCT Filed: Sep. 9, 2004
(86) PCT No.: PCT/US04/29420

§ 371 Date: Sep. 13, 2005

(51) Int. Cl. H01R 33/00

(52) U.S. Cl. 439/34

(57) ABSTRACT

An electrical actuator is characterized by applying electrical power directly to a smart muscle wire to produce an output motion of the electrical actuator. The smart muscle wire is attached to a moveable member, for example a slide or a lever, to produce the output motion. The smart muscle wire is preferably fixed at each end and looped around a reaction member that is attached to the moveable member either as a separate or an integral part, to double the force that is applied to move the moveable member of the electrical actuator. The force and/or the stroke of the electrical actuator can be designed to meet various requirements easily by changing wire diameter and/or length.

This application claims priority of U.S. Provisional Patent Application No. 60/501,279 filed Sep. 9, 2003.

This invention relates generally to actuators and more particularly to electrical actuators for operating a mechanical device.

Mechanical devices, such as power operated automotive closure latches for doors, tail gates and the like, that can be unlatched, unlocked and locked are already known. These mechanical devices closure latches generally include a “power unit” comprising an electric motor or solenoid that operates a plurality of mechanical components including all kinds of gears, springs, slides and levers, that in turn operate the unlatching lever or lock lever of the closure latch. Such power units which depend on an electric motor or solenoid, have one or more of the following drawbacks. The power unit is complex and costly, and/or is sensitive to environmental conditions, and/or is noisy, and/or is subject to wear and/or requires substantial space.

This invention provides a “power unit” that is in the form of an electrical actuator that is characterized by applying electrical power directly to a smart muscle wire. The electrical actuator overcomes one or more of the drawbacks of the prior art noted above, particularly with respect to reducing complexity and cost by reducing the number of mechanical components required for the power unit.

Applying electrical power directly to the smart muscle wire produces an output motion for the electrical actuator while eliminating the need for either an electric motor or a solenoid. The smart muscle wire is attached to a moveable member, for example a slide or a lever, to produce the output motion. The smart muscle wire is preferably fixed at each end and looped around a reaction member that is attached to the moveable member either as a separate or an integral part, to double the force that is applied to move the moveable member of the electrical actuator. The force and/or the stroke of the electrical actuator can be designed to meet various requirements easily by changing wire diameter and/or length.

In the accompanying drawings,

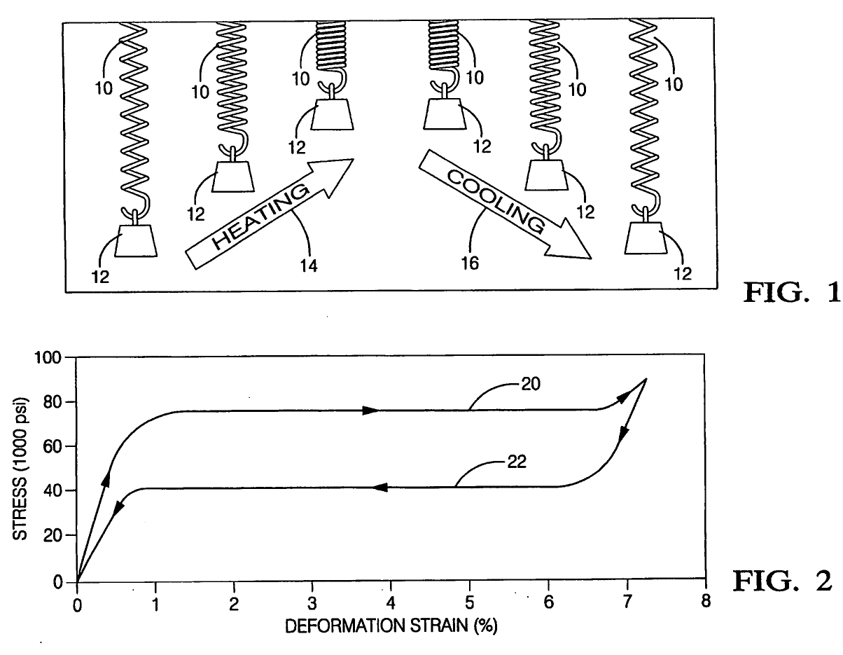

FIG. 1 is a schematic diagram for explaining a characteristic of a smart muscle wire;

FIG. 2 is a stress strain curve of an example of a smart muscle wire;

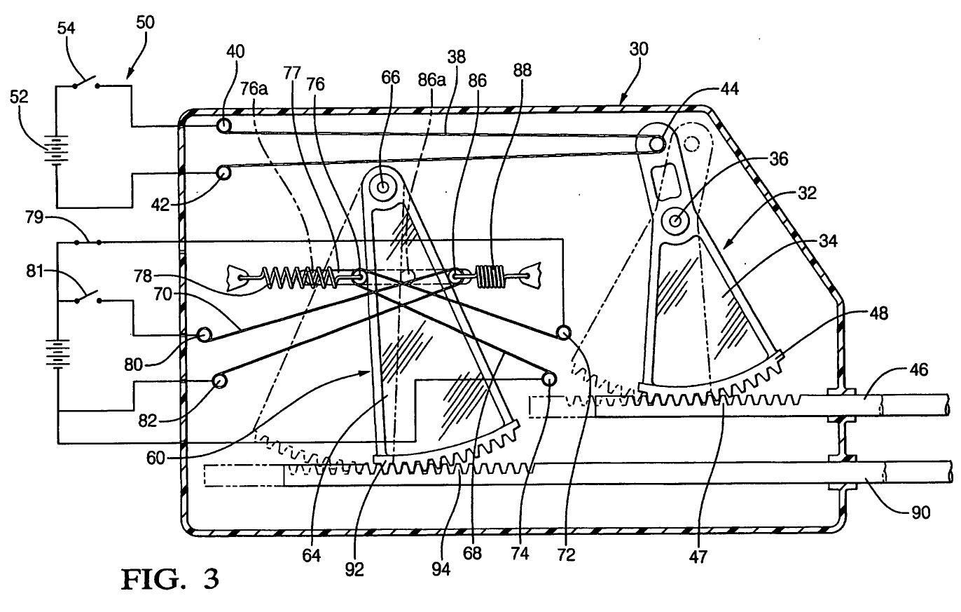

FIG. 3 is a schematic drawing of an electrical actuator of the invention characterized by a smart muscle wire;

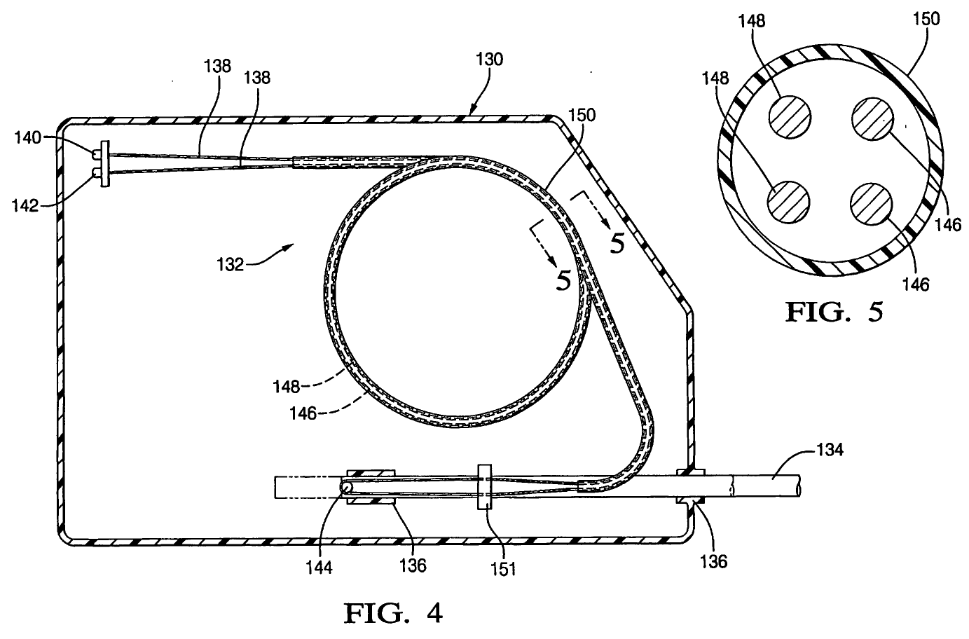

FIG. 4 is a schematic drawing of another electrical actuator of the invention characterized by a smart muscle wire;

FIG. 5 is an enlarged section of a portion of FIG. 4;

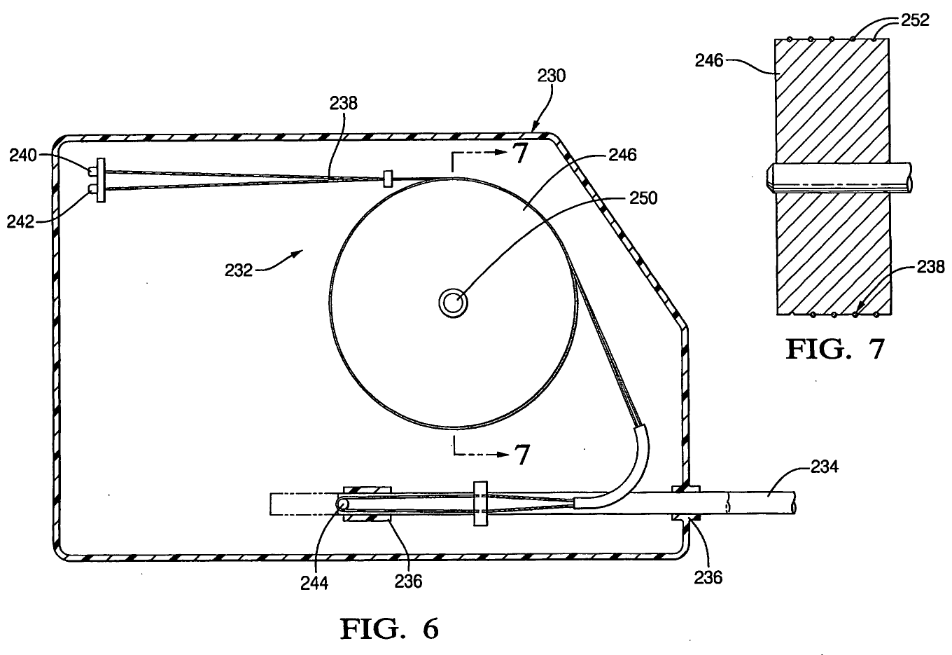

FIG. 6 is a schematic drawing of still another electrical actuator of the invention characterized by a smart muscle wire;

FIG. 7 is a section taken substantially along the line A-A of FIG. 6 looking in the direction of the arrows; and

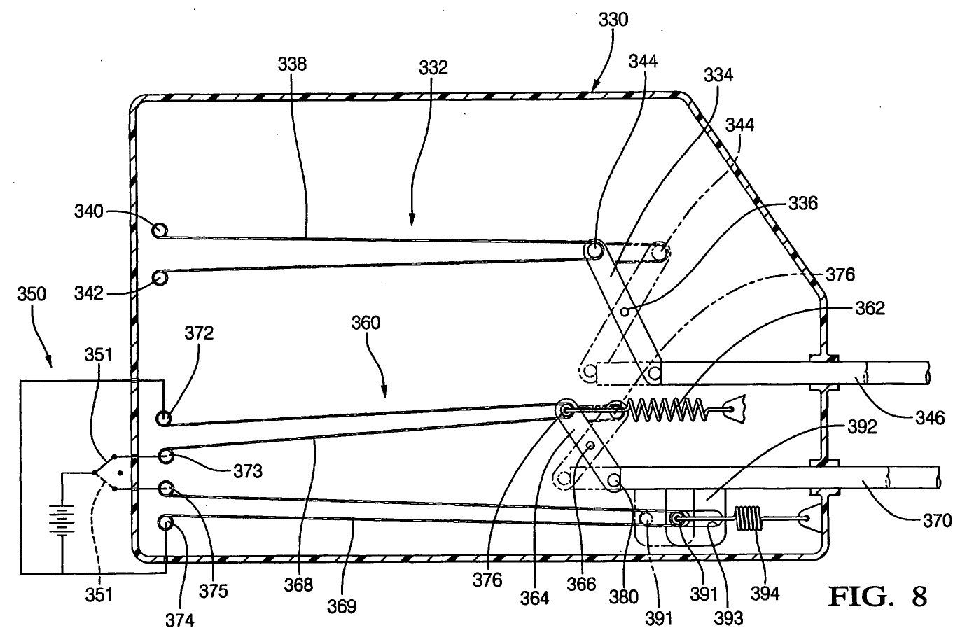

FIG. 8 is a schematic drawing of yet another electrical actuator of the invention characterized by a smart muscle wire.

Referring now to the schematic diagram of FIG. 1, a coiled wire 10 made of a smart muscle material is illustrated. Smart muscle material, which is also known as a memory material, is characterized by a shape change responsive to heating and a return to its original shape upon cooling.

An example of a suitable muscle or memory material for the invention is nickel-titanium (NiTi) alloy which expands when heated and contracts when cooled. A wire made of nickel-titanium alloy is represented in FIG. 1 functioning as the coiled wire 10 (of solid round cross section) that supports a weight 12. The electrical resistance of the metallic alloy wire 10 is high so that the wire is heated by applying electric current directly to the wire. The metallic alloy wire expands and contracts between its Martensite and Austentite (phase) transformation which is achieved by heating the wire 10 while it is under the fixed load of weight W. As the metallic alloy wire 10 heats up, wire 10 contracts and raises the weight 12 as indicated by the three left hand figures and the upward slanting heating arrow 14 of FIG. 1. Then as wire 10 cools down, wire 10 expands back to its original shape as indicated by the three right hand figures and the downward slanting cooling arrow 16.

FIG. 2 illustrates the typical loading and unloading that is, the heating and cooling behavior of superelastic nickel titanium (NiTi) alloy. When the material is loaded, the percentage of deformation strain is low initially, that is up to about 1%. The percentage of deformation is then very high increasing up to about 6½% with very little increase in stress. The percentage of deformation strain is then low again. This behavior is shown in the upper curve 20 of FIG. 2. The lower curve 22 shows the behavior of the alloy as the load is removed and the stress returns to zero.

Referring now to FIG. 3, a schematic drawing of an electrical actuator 30 of the invention is illustrated. Actuator 30 is designed to operate a mechanical device such as a closure latch (not shown) which typically includes an unlatching lever and a lock/unlock lever.

The unlatching lever of the closure latch is typically moved from a latching position to an unlatching position against the action of a return spring to disengage a detent from a fork bolt to release the fork bolt for movement to an unlatched position. The unlatching lever is then held in the unlatching position by the fork bolt in the unlatched position. The return spring moves the unlatching lever back to the latching position when the fork bolt is moved to a latching position by shutting the closure with which the closure latch is associated.

Actuator 30 includes a one-way version 32 for operating the typical unlatching lever of a closure latch or like mechanical device that includes its own return spring. Basically the one-way version 32 comprises a lever 34 that pivots on a pivot pin 36 and a smart muscle wire 38 that contracts when heated and expands when cooled. Wire 38 is attached to lever 34 to pivot the lever 34 with the force applied to lever 34 being dependent on the diameter of wire 38. As indicated above, wire 38 is preferably fixed at its respective ends to spaced electric terminals 40 and 42 and looped around a reaction member or drive pin 44 that is attached to lever 34 above pivot pin 36 to double the force applied to lever 34. Drive pin 44 may be attached to lever 34 as a separate part or an integral part.

When wire 38 is heated, wire 38 contacts pivoting lever 34 counterclockwise about pivot pin 36 from the phantom line position to the solid line position shown in FIG. 3. Lever 34 is mechanically connected to link 46 and moves link 46 to the right as shown by the solid line position of link 46. Link 46 in turn may be connected to the unlatching lever of a closure latch (not shown) to move the unlatching lever to the unlatching position, that is, from one operative position to another operative position.

As schematically illustrated, lever 34 includes a sector gear 48 and link 46 is attached to a rack bar 47 having teeth that mesh with the sector gear 48 so that rack bar 47 and link 46 translate to the right to the solid line position shown in FIG. 3 when lever 34 pivots counterclockwise. Other mechanical linkages between lever 34 and link 46 are possible and it may even be possible to connect lever 34 directly to the unlatching lever of the closure latch or other part of a power operated mechanical device.

Smart muscle wire 38 typically has a high electrical resistance and consequently can be heated electrically as schematically shown in FIG. 3 by electric circuit 50 that is connected to terminals 40 and 42 and that includes an electrical power source 52 and a switch 54.

The locking lever of the closure latch (not shown) is typically moved back and forth between a lock position and an unlock position and held in either position by a toggle or over center device within the closure latch. Actuator 30 also includes a two-way version 60 for operating the typical locking lever of a closure latch or the like. Basically the two-way version 60 comprises a lever 64 that pivots on a pivot pin 66 and two opposed smart muscle wires 68 and 70 that contract when heated and expand when cooled to operate two spring biased slides 76 and 86.

Wire 68 is fixed to spaced electric terminals 72 and 74 at its respective ends which are on one side of lever 64 (the right side as shown in FIG. 3) and looped around a reaction member of slide 76 that is on an opposite side of lever 64 (the left side as shown in FIG. 3). Slide 76 slides in slot or track 77 and is held in position in slot 77 by wire 68 and an opposing tension spring 78 or the like as shown in FIG. 3.

Wire 70 is fixed to spaced electric terminal 80 and 82 at its respective ends which are on one side of lever 64 (the left side as shown in FIG. 3) and looped around a reaction member of slide 86 that is on an opposite side of lever 64 (the right side as shown in FIG. 3). Slide 86 slides in slot 77 and is held in position in slot 77 by wire 70 and an opposing tension spring 88 or the like as shown in FIG. 3.

Lever 64 is shown in a first operative position in FIG. 3 in phantom line and in a second operative position in solid line. During operation lever 64 is held either in the first operative position shown in phantom line or in the second operative position shown in solid line by conventional or other well known toggles or over-center devices (not shown). When lever 64 is in the first operative position shown in phantom, slide 76 is at position 76a engaging lever 64 while slide 86 is held in the solid line position away from lever 64 by spring 88. To move lever 64 to the second operative position shown in solid line, switch 79 is closed heating wire 68. When wire 68 is heated, wire 68 contacts pulling slide 76 to the right as viewed in FIG. 3 to the solid line position. Slide 76 in turn pivots lever 64 counterclockwise about pivot pin 66 to the second operative position and into engagement with slide 86. Lever 64 is mechanically connected to link 90 and moves link 90 to the right from the phantom line position to the solid line position shown in FIG. 3. Link 90 in turn may be connected to the lock lever of a closure latch (not shown) to move the lock lever from the lock position to the unlock position or vice versa. When switch 79 is opened and wire 68 cools down, slide pin 76 is returned to the phantom position 76a shown in FIG. 3 and held away from lever 64 by spring 78. However, lever 64 is held against slide 86 by the lock lever of the closure latch which is held in position by a toggle or over center device within the closure latch as indicated above.

Lever 64 is moved back to the first operative position and engaging slide 76 by closing switch 81 and heating wire 70. When wire 70 is heated, wire 70 contacts and slide 86 slides to position 86a and pivots lever 64 clockwise about pivot pin 66 back to the first operative position shown in the phantom line and into engagement with slide 76 at position 76a. Lever 64 is mechanically connected to link 90 and moves link 90 back to the left from the solid line position to the phantom line position shown in FIG. 3. Link 90 in turn moves the lock lever of the closure latch (not shown) back to the lock position or to the unlock position. When wire 70 cools down, slide 86 is returned to the solid line position shown in FIG. 3 by spring 88. However, lever 64 is held against slide 76 at position 76a by the lock lever of the closure latch which is held in position by a toggle or over center device within the closure latch.

As schematically illustrated, lever 64 includes a sector gear 92 and link 90 is attached to a rack bar 94 having teeth that mesh with the sector gear 92 so that rack bar 94 and link 90 translate to the right or to the left when lever 64 pivots. As in the case of the one-way version 32, other mechanical linkages are possible and it may even be possible to connect lever 64 directly to the lock lever of the closure latch or other part of a power operated mechanical device.

Smart muscle wires 68 and 70 typically have a high electrical resistance and consequently can be heated electrically as schematically shown in FIG. 3 by an electric circuit such as the electric circuit 55 that is connected to terminals 72, 74, 80 and 82 and that includes an electrical power source 83 and switches 79 and 81. Switches 79 and 81 can be open at the same time. However, switches 79 and 81 cannot be closed at the same time. In this regard, a three-way switch such as the three-way switch 351 illustrated schematically in FIG. 8 can be used.

Referring now to FIG. 4, a schematic drawing of another electric actuator 130 of the invention is illustrated. Actuator 130 is also designed to operate an unlatching lever of a closure latch (not shown). Consequently electrical actuator 130 is a one-way version 132 (for operating the typical unlatching lever of a closure latch or the like) that reduces the space requirements of the one-way version 32 of actuator 30 which includes lever 34 to gain a mechanical advantage. Basically the one-way version 132 of electrical actuator 130 simply comprises a slide 134 that is guided by a slide or track 136 and smart muscle wire 138 that contracts when heated and expands when cooled. Wire 138 is fixed to spaced electric terminal 140 and 142 at its respective ends and looped around a drive member 144 that is attached to slide 134 at the left hand end as shown in FIG. 4. When wire 138 is heated, wire 138 contacts moving slide 134 to the right from the phantom line position to the solid line position shown in FIG. 4. Slide 134 in turn may be connected to the unlatching lever of a closure latch (not shown) or the like to move the unlatching lever to the unlatching position.

Wire 138 preferably includes one or more coils 146 between terminal 140 and pin 144 and one or more coils 148 between terminal 142 and pin 144 to increase the length of wire 138 in a small space with the increased length increasing the movement or stroke of slide 134. As best shown in FIG. 5, the lengths of wire forming the coils 146 and 148 may be moveably disposed in flexible tubing 150, similar to a bowden cable, to prevent entanglement of the wire in the coils. A wire guide 151 may also be provided.

Smart muscle wire 138 typically has a high electrical resistance and consequently can be heated electrically by a suitable electric circuit connected to terminals 140 and 142 such as circuit 50 that is schematically shown in FIG. 3 and that includes an electrical power source 52 and a switch 54.

One-way version 132 can be converted to a two-way version by using a second smart muscle wire that is connected to a second set of terminals and looped around a drive pin at the right end of slide link 134 to pull slide link 134 to the left when the second wire is heated. Actuator 130 may include both a one-way version and a two-way version.

Referring now to FIG. 6, a schematic drawing of yet another electrical actuator 230 of the invention is illustrated. Actuator 230 is also designed to operate a an unlatching lever of a closure latch (not shown) or the like which typically includes a return spring for the unlatching lever. Consequently actuator 230 is a one-way version 232 for operating the typical unlatching lever of a closure latch or the like that also reduces the space requirements of the actuator 30 which includes lever 34. Basically the one-way version 232 of electrical actuator 230 comprises a slide link 234 that is guided by a slide or track 236 and smart muscle wire 238 that contracts when heated and expands when cooled. Wire 238 is fixed to spaced electric terminal 240 and 242 at its respective ends and looped around a drive pin 244 that is attached to slide link 234 at the left hand end as shown in FIG. 6. When wire 238 is heated, the wire contacts moving slide link 234 to the right as shown by the solid position of slide link 234 in FIG. 6. Slide link 234 in turn may be connected to the unlatching lever of a closure latch (not shown) or the like to move it from one operative position to another.

Wire 238 preferably includes one or more loops between terminal 240 and drive pin 244 and one or more loops between terminal 242 and pin 244 to increase the length of wire 238 in a small space with the increased length increasing the movement or stroke of slide link 234. Actuator 230 includes at least one reel 246 that is located between the terminals 240 and 242 and the slide link 234. Wire 238 is wound around reel 246 between terminal 240 and drive pin 234 and wound around reel 246 between terminal 242 and drive pin 244. Reel 246 preferably has a helical groove 252 to separate loops of wire wound on the reel as best shown in FIG. 7. Reel 246 is also preferably made of a low friction material allowing the wire 238 to slide in the helical groove 252. Reel 246 may also be pivotally mounted on a pivot pin 250.

Smart muscle wire 238 typically has a high electrical resistance and consequently can be heated electrically by a suitable electric circuit connected to terminals 240 and 242 such as circuit 50 that is schematically shown in FIG. 3 and that includes an electrical power source 52 and a switch 54.

The one-way version 232 of actuator 230 can be converted to a two-way version by using a second smart muscle wire that is connected to a second set of terminals looped around a drive pin at the right end of slide link 234 to pull slide link 234 to the left when the second wire is heated.

Referring now to FIG. 8, an electrical actuator 330 similar to electrical actuator 30 is shown. Electrical actuator 330 includes a one-way version 332 for operating the typical unlatching lever of a closure latch or like mechanical device that includes its own return spring. Basically the one-way version 332 comprises a lever 334 that pivots on a pivot pin 336 and a smart muscle wire 338 that contracts when heated and expands when cooled. Wire 338 is attached to lever 334 to pivot the lever 334, the force applied to lever 334 being dependent on the diameter of wire 338. As indicated above, wire 338 is preferably fixed at its respective ends to spaced electric terminals 340 and 342 and looped around a reaction member or drive pin 344 that is attached to lever 334 above pivot pin 336 to double the force applied to lever 334. Drive pin 344 may be attached to lever 334 as a separate part or an integral part.

When wire 338 is heated, the wire contracts pivoting lever 34 counterclockwise about pivot pin 336 from the phantom line position to the solid line position shown in FIG. 8. Lever 334 is pivotally connected to link 346 and slides link 346 to the right as shown by the solid line position of link 346. Link 346 in turn may be connected to the unlatching lever of a closure latch (not shown) or the like to move the unlatching lever to the unlatching position, that is, from one operative position to another operative position.

Smart muscle wire 338 typically has a high electrical resistance and consequently can be heated electrically as schematically shown in FIG. 3 by electric circuit 50 that is connected to terminals 340 and 342 and that includes an electrical power source 52 and a switch 54.

Actuator 330 also includes a two-way version 360 for operating the typical locking lever of a closure latch or the like. Basically the two-way version 360 comprises a lever 364 that pivots on a pivot pin 366 and smart muscle wires 368 and 369 that contract when heated and expand when cooled to operate slide link 370.

Wire 368 is attached to fixed spaced electric terminals 372 and 373 at its respective ends and looped around a reaction pin or member 376 attached to lever 364 at one end. The opposite end of lever 334 has a push pin 380 engaging the end of slide link 370. Wire 369 is attached to fixed, spaced electrical terminals 374 and 375 at its respective ends and looped around a reaction pin or member 391 that is attached to slide link 370 by a tab 392.

Link 370 is shown in a first operative position in FIG. 8 in phantom line and in a second operative position in solid line. During operation lever 370 is held either in the first operative position shown in phantom line or in the second operative position shown in phantom solid line by conventional or other well known toggles or over-center devices (not shown). When link 370 is in the first operative position shown in phantom, lever 364 and slide link 370 are in the phantom line positions shown in FIG. 8. To move link 370 to the second operative position shown in solid line, wire 368 is heated for instance by moving a three-way switch 351 in a typical electric circuit 350 to close the electric circuit through wire 368 via terminals 372 and 373. When wire 368 is heated, wire 368 contracts pivoting lever 364 counterclockwise with push pin 380 pushing slide link 370 to the right as viewed in the solid line positions in FIG. 8.

Slide link 364 is moved back to the first operative position shown in phantom line position in FIG. 8 by heating wire 369 which then contracts and pulls slide link 370 back to the left to the phantom line position via reaction pin 391. Wire 369 may be heated by moving three-way switch 351 to the phantom line position shown in FIG. 8. This closes the electric circuit to the wire 369 via terminal 375 and opens the electric circuit to wire 368 at the same time. Thus wire 369 is heated and contracts while wire 368 simultaneously cools and expands.

Switch also can be moved to a neutral position without heating either wire 368 or 369. In such a case, lever 364 requires the optional return spring 362 while reaction pin 391 requires an optional slot 393 in tab 392 and an optional return spring 394.

While the smart muscle wires have been disclosed as being of round solid cross section, other cross sections are possible such as oval or rectangular. Moreover, the smart muscle wires can be tubular rather than solid. Furthermore, the smart muscle wires can be coiled wires.

Many embodiments and adaptations of the present invention other than those described above, as well as many variations, modifications and equivalent arrangements, will be apparent from or reasonably suggested by the present invention and the foregoing description, without departing from the substance or scope of the present invention. Accordingly, while the present invention has been described herein in detail in relation to preferred embodiments, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the following claims and the equivalents thereof.

I claim:

1. An electrical actuator characterized by a smart muscle wire that is fixed at least at one end and attached to a moveable member, the smart muscle wire contracting when heated and moving the moveable member from one position to another position.

2. The electrical actuator of claim 1 wherein the smart muscle wire is fixed at each end and looped around a reaction member attached to the moveable member between the fixed ends.

3. The electrical actuator of claim 1 wherein the smart muscle wire is made of a nickel-titanium alloy.

4. The electrical actuator of claim 3 wherein the smart muscle wire contracts when heated and returns to its original shape upon cooling.

5. The electrical actuator of claim 1 wherein the moveable member is a lever that is pivoted by the wire when the wire is heated.

6. The electrical actuator of claim 1 wherein the moveable member is a slide that is pulled when the wire is heated.

7. The electrical actuator of claim 1 wherein the electrical actuator includes a second smart wire that is fixed at one end and attached to a second moveable member.

8. The electrical actuator of claim 7 wherein the moveable member is a spring biased slide and wherein the second moveable member is a second spring biased slide.

9. The electrical actuator of claim 7 wherein the moveable member is a lever that moves the second moveable member.

10. The electrical actuator of claim 1 wherein the smart muscle wire has at least one coil.

11. The electrical connector of claim 1 wherein the smart muscle wire has a plurality of coils.

12. The electrical actuator of claim 1 wherein the smart muscle wire is heated by an electric circuit connected to the ends of the wire.

13. The electrical actuator of claim 2 wherein the smart muscle wire is made of a nickel-titanium alloy.

14. The electrical actuator of claim 2 wherein the smart muscle wire contracts when heated and returns to its original shape upon cooling.

15. The electrical actuator of claim 2 wherein the moveable member is a lever that is pivoted by the wire when the wire is heated.

16. The electrical actuator of claim 2 wherein the moveable member is a slide that is pulled when the wire is heated.

17. The electrical actuator of claim 2 wherein the electrical actuator includes a second smart wire that is fixed at each end and looped around a second reaction member that is attached to a second moveable member.

18. The electrical actuator of claim 17 wherein the moveable member is a spring biased slide and the second moveable member is a second spring biased slide.

19. The electrical actuator of clam 17 wherein the moveable member is a lever that moves the second moveable member.

20. The electrical actuator of claim 2 wherein the smart muscle wire has at least one coil between each fixed end and the reaction member.

21. The electrical connector of claim 2 wherein the smart muscle wire has a plurality of coils between each fixed end and the reaction member.

22. The electrical actuator of claim 21 wherein the coils are disposed in a tubular jacket.

23. The electrical actuator of claim 21 wherein the coils are wrapped around a spool.

24. The electrical actuator of claim 21 wherein the smart muscle wire is heated by an electric circuit connected to the fixed ends of the wire.
